(19) United States
(12) Patent Application Publication
(10) Pub. No.: US 2005/0127227 A1
(43) Pub. Date: Jun. 16, 2005

(54) Safety belt retractor having a small-structure rotation damper

(76) Inventors: Kay Loffler, Halstenbek (DE); Geert Helge Wittenberg, Norderstedt (DE)

Correspondence Address: Robert W Becker & Associates, 707 Highway 66 East, Suite B, Tijeras, NM, 87059, US

(21) Appl. No.: 10/501,782

(22) PCT Filed: Jan. 15, 2003
(86) PCT No.: PCT/EP03/00354

(30) Foreign Application Priority Data
Jan. 17, 2002 (DE) 102015376

(51) Int. Cl. B60R 22/28

(52) U.S. Cl. 242/379.1

(57) ABSTRACT

A safety belt retractor is provided that has a force limiting device that operates with a viscous medium. The belt shaft is adapted to be coupled with a central shaft that carries a socket type piston that is movable relative to a fixed counter socket, whereby due to relative movement the viscous medium is forced between the socket type piston and the counter sockets, thereby effecting a force limitation.

The invention relates to a safety belt retractor, especially in motor vehicles, and has a belt shaft as a carrier for a belt strap wound thereon, as well as a blocking mechanism, for the belt shaft, that can be actuated in a vehicle sensitive and/or belt strap sensitive manner, and also includes a force limiting device that becomes effective in the event of blocking, wherein the force limiting device comprises a housing that is filled with a viscous medium and has at least one fixed contour and a counter contour that is coupled to the belt shaft in the event of a blocking so that due to the relative movement of contour and counter contour, the medium is forced between the associated surfaces.

A safety belt retractor having the aforementioned features is described in WO 01/58728 A1. With the known belt retractor, the cylindrical housing of the force limiting device is attached to the outer side of the belt retractor and is coupled with the belt shaft or in particular with a torsion rod.

Pursuant to one embodiment, disposed in the housing of the force limiting device, which housing is filled in particular with siliconee as the viscous medium, is a sequence of stationary apertured disk, between which, via a radially projecting piston lobe, engage disk pistons that are connected to the torsion rod, the rotational movement of which is to be dampened. Upon relative movement of disk pistons and apertured disks relative to one another, the silicone is forced between the disk surfaces, so that the intended force consumption and hence the force limitation occur.

With the known safety belt retractor and the force limiting device thereof, one still has the drawback of a correspondingly great axial overall width, because in particular the arrangement of a disk packet that makes adequate shearing forces available requires a greater axial extent of the housing of the force limiting device. It is therefore an object of the invention to reduce the overall size of a safety belt retractor having the aforementioned general features.

The realization of this object, including advantageous embodiments and further developments of the invention, result from the content of the patent claims that follow this description.

The invention provides that a central shaft is disposed on the end of the belt shaft and extends around the belt shaft, wherein upon activation the central shaft can be coupled with the belt shaft via a radially deflectable ratchet wheel that is mounted on the belt shaft as a blocking mechanism, with the central shaft, together with an outer housing wall, forming the housing of the force limiting device, and that on a radial shoulder that forms an end wall of the housing, the central shaft is provided with at least one socket that extends in the peripheral direction and projects axially into the inner space of the housing that is filled with the viscous medium, wherein the socket cooperates with a counter socket that is disposed on the oppositely arranged cover that is fixed to the housing, wherein the counter socket is radially offset from, and has a corresponding shape, to the socket.

The invention has the advantage that the housing of the force limiting device engages about a portion of the belt shaft, so that the axial overall width of an inventively equipped safety belt retractor is kept correspondingly small. Due to the end faces of the belt shaft and force limiting device, which to this extent are disposed in a single plane, the known blocking system of a self-locking belt retractor having the radially deflectable ratchet wheel, which can be actuated in a vehicle sensitive and/or belt strap-sensitive manner, for the interlocking of the belt shaft with the force limiting device, can be used in that the central shaft, which extends around the belt shaft, is provided with the toothing, which with conventional belt retractors is otherwise formed in the housing frame, for the engagement of the ratchet wheel, which is mounted on the belt shaft in a way that it can be deflected radially. Also with a view toward reducing the overall size, pursuant to the invention the surfaces that force the viscous medium, preferably silicone, between them are oriented in a course that is disposed axially and hence parallel to the belt shaft, with the socket and the counter socket projecting axially from the end walls of the housing of the force limiting device and extending in the peripheral direction of the central shaft and of the belt shaft. In this connection, it is expedient if pursuant to an embodiment of the invention at least two sockets that project axially into the inner space of the housing are provided, between which engage counter sockets that with a corresponding shape are disposed on the cover. The sequence of sockets and counter sockets is such that a respective counter socket engages into the space between the housing wall and the first socket, or between two sockets. Depending upon the radial installation space that is available, and the distance required between the forcing surfaces of sockets and counter sockets, or expediently as a function of the viscous medium, a number of alternatingly arranged sockets and counter sockets can be provided. To the extent that in principle the sockets that are connected with the central shaft can also be formed directly on the central shaft, it is provided pursuant to an alternative embodiment that the sockets be a component of a socket type piston that is disposed in the inner space of the housing and is positively connected with the central shaft.

In this connection, the sockets do not have to extend over the entire periphery of the central shaft; rather, it is sufficient for the sockets to extend over a partial periphery of the central shaft, whereby in particular two oppositely disposed socket sections can be formed.

The central shaft, via appropriately interposed bearing ring can be supported via the housing wall and/or the cover of the housing of the force limiting device, in which case the cover surrounds or extends around the central shaft.

To secure the force limiting device on the safety belt retractor, that end of the housing wall that extends around the cover can be secured via radially projecting projections or tabs that in the manner of a bayonet closure engage in receiving means formed on the belt retractor housing.

The drawing shows an embodiment of the invention, which will be described subsequently. The drawings show:

FIG. 1 a side view of a safety belt retractor,

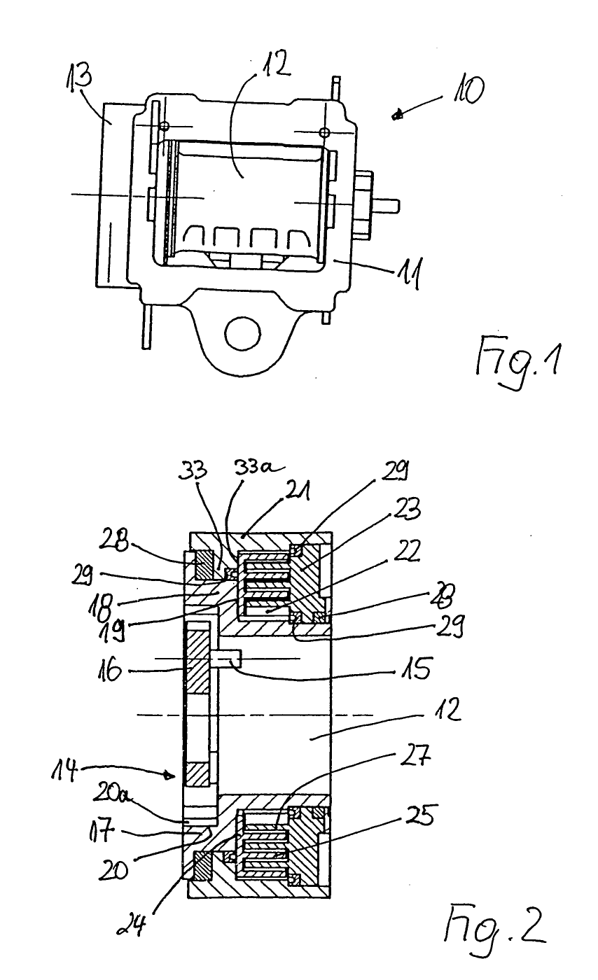

FIG. 2 a cross-sectioned detailed illustration of the pertaining force limiting device,

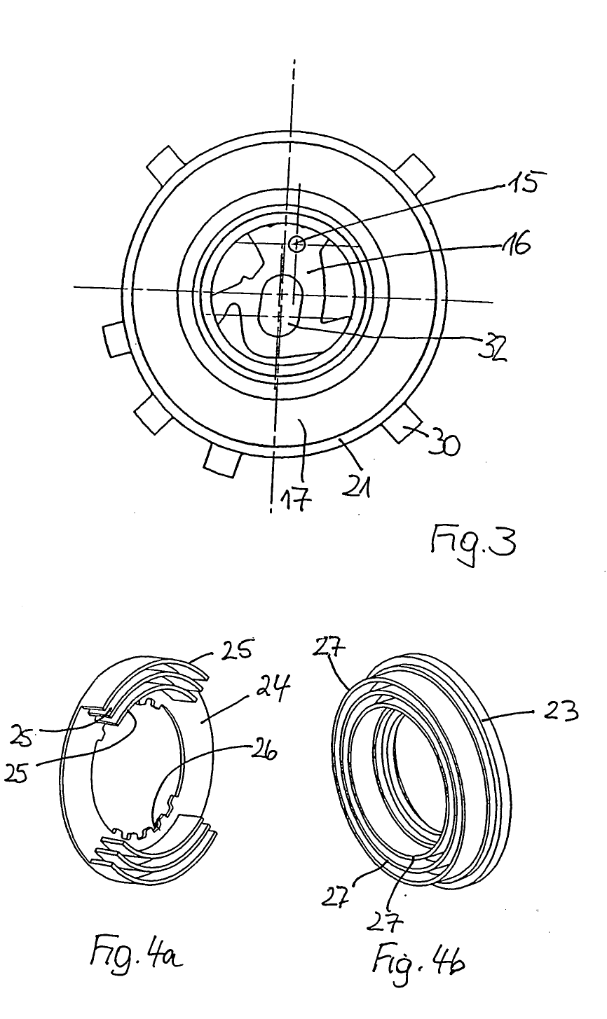

FIG. 3 an end view of the force limiting device of FIG. 2,

FIGS. 4a & 4b respective detailed views of the socket type piston and housing cover with the sockets and counter sockets that are provided with the forcing surfaces.

The safety belt retractor 10 illustrated in FIG. 1 has a U-shaped belt retractor housing 11, in which a belt shaft 12 is mounted. Disposed on one end face of the belt shaft 12, i.e. of the belt retractor housing 11, is a housing 13 of a force limiting device, which will be described in detail.

As can be seen in greater detail from FIG. 2, a ratchet wheel 16 that can swing out radially is mounted on the end face 14 of the belt shaft 12 on a journal pin 15; the ratchet wheel is mounted on the associated end of the belt shaft 12 via a slot 32 (FIG. 3), so that the radial deflection of the ratchet wheel 16 is possible with a control that is sensitive to a belt strap and/or a vehicle.

Placed upon the associated end of the belt shaft 12 is a central shaft 17 that surrounds the belt shaft and that at its outer end is provided with an outwardly projecting, Z-shaped angled portion 18. In this way, formed on the inner side of the central shaft 17 that faces the belt shaft 12 is an axial wall section 20 having the toothing 20a formed thereon for the engagement of the ratchet wheel 16 during deflection thereof, while formed on the outer side of the central shaft 17, i.e. of the angled portion 18, is an outwardly extending radial wall section 19.

An outer housing shell or wall 21, accompanied by the formation of an inner space 22 of the housing, surrounds the central shaft 17, whereby a cover 23, which is secured to the housing, is disposed across from and at an axial distance from the radial wall section 19 of the angled portion 18. By means of a projection 33, the housing wall 21 extends inwardly against the angled portion 18 of the central shaft 17, i.e. the axially extending section thereof, so that the surface 33a of the projection 33 that faces the inner space 22 of the housing is aligned with the radial wall section 19 of the central shaft 17. Thus, the inner space 22 of the housing is defined by corresponding wall sections of the central shaft 17, the housing wall 21, and the cover 23. In the illustrated embodiment, a separate shell or socket type piston 24 is disposed in the inner space 22 of the housing; the socket type piston rests against the end wall formed from the radial wall section 19 of the angled portion 18 of the central shaft 17, and the surface 33a of the projection 33, and from which extend shells or sockets 25 that project axially into the inner space 22 of the housing. As can be seen from FIG. 4a, three sockets 25 are provided that are radially spaced from one another and that respectively extend over only a partial periphery of the socket type piston 24, whereby on the opposite sides of the socket type piston 24 two respective sequences of socket segments 25 are disposed.

As can be seen from FIGS. 2 and 4b, disposed on the cover 23, which is secured to the housing, are counter shells or sockets 27 that have a corresponding shape and that extend between the socket segments 25 of the socket type piston 24.

A bearing ring 28 is disposed between the angled portion 18 of the central shaft 17 and the housing wall 21, so that during its rotation the central shaft 17 is supported against the housing 13 of the force limiting device; a second bearing ring is disposed between the outer periphery of the central shaft 17 and the cover 23 of the housing 13 of the force limiting device, which cover surrounds the central shaft. Furthermore, a plurality of sealing means 29 are provided for the sealing of the inner space 22 of the housing.

As can be seen from FIG. 3, disposed on the outer housing wall 21 of the housing 13 of the force limiting device are radially extending projections or tabs 30, which engage in the manner of a bayonet closure in receiving means provided on the outer side of the belt retractor housing 11, so that the housing 13 of the force limiting device is positively interlocked with the belt retractor housing 11.

During normal use of the safety belt retractor, the belt shaft 12 rotates within the central shaft 17 that surrounds it, without the force limiting device being actuated. In the event of a triggering, there is effected, in a vehicle-sensitive and/or belt strap-sensitive manner, and in a way known per se, an activation of the ratchet wheel 16, which is brought into engagement with the toothing 20a on the central shaft 17, so that the central shaft 18 is fixedly coupled on the belt shaft 12. Since the central shaft 17 in turn is fixedly connected with the socket type piston 24, upon rotation of the belt shaft 12, the socket type piston 24 is also caused to rotate, whereby the silicone present in the inner space 22 of the housing is displaced and is forced between the surfaces of the sockets 25 and counter sockets 27. By means of the frictional resistance caused thereby, the force is limited to a level established by the rotational speed of the belt shaft 12.

The features of the subject matter of these documents disclosed in the preceding description, the patent claims, the abstract, and the drawing can be important individually as well as in any desired combination with one another for realizing the various embodiments of the invention.

1-8. (canceled)

9. A safety belt retractor, comprising:
a belt shaft has a carrier for a belt strap to be wound thereon;
a blocking mechanism, for said belt shaft, that is actuatable in at least one of a vehicle and a belt strap sensitive manner, wherein said blocking mechanism comprises a ratchet wheel that is mounted on said belt shaft and is adapted to be deflected radially;
a force limiting device that becomes effective in the event of a blocking, wherein said force limiting device comprises a housing, an inner space of which is filled with a viscous medium;
a central shaft that is disposed on an end of said belt shaft and extends around said belt shaft, wherein upon an actuation of said force limiting device, said central shaft is adapted to be coupled with said belt shaft via said ratchet wheel, wherein said housing of said force limiting device is formed by an outer housing wall and said central shaft, wherein said central shaft is provided with a radially extending shoulder that forms an end wall of said housing, and wherein on said shoulder said central shaft is provided with at least one socket that extends in a peripheral direction and projects axially into said inner space of said housing that is filled with said viscous medium;
a cover that is secured to said housing across from said central shaft, wherein said cover is provided with at least one counter socket that is radially offset from, and has a corresponding shape to, said at least one socket, wherein said at least one socket is coupled to said belt shaft in the event of a blocking so that due to relative movement and cooperation between said at least one counter socket and said at least one socket, said medium is forced between associated surfaces thereof.

10. A safety belt retractor according to claim 9, wherein at least two sockets are provided that project axially into said inner space of said housing, and wherein said counter sockets engage between said sockets.

11. A safety belt retractor according to claim 10, wherein said sockets are a component of a socket type piston that is disposed in said inner space of said housing and is positively connected with said central shaft.

12. A safety belt retractor according to claim 10, wherein said sockets extend over a partial periphery of said central shaft.

13. A safety belt retractor according to claim 12, wherein two oppositely disposed socket sections are provided.

14. A safety belt retractor according to claim 9, wherein said central shaft is supported against said outer housing wall of said housing of said force limiting device via a bearing ring that is interposed between said central shaft and said housing wall.

15. A safety belt retractor according to claim 9, wherein a bearing ring is disposed between said central shaft and said cover of said housing of said force limiting device, and wherein said cover extends around said central shaft.

16. A safety belt retractor according to claim 9, wherein said outer housing wall of said housing of said force limiting device has an end that extends around said cover and is provided with radially extending projections that, in the manner of a bayonet closure, engage in receiving means formed on a housing of said belt retractor.
